(19) United States
(12) Patent Application Publication
(10) Pub. No.: US 2016/0267451 A1
(43) Pub. Date: Sep. 15, 2016

(54) PAYMENT PROCESSING BASED ON VEHICLE REMOTE IDENTIFICATION

(71) Applicant: Gilbert Eid, Kahhaleh (LB)

(72) Inventor: Gilbert Eid, Kahhaleh (LB)

(21) Appl. No.: 15/163,706

(22) Filed: May 25, 2016

Related U.S. Application Data
(63) Continuation-in-part of application No. 14/258,584, filed on Apr. 22, 2014.
Application No. 14/258,584 is a continuation-in-part of application No. 14/172,025, filed on Feb. 4, 2014.

(51) Int. Cl. G06Q 20/10; G06Q 20/40; H04L 29/06; G06K 19/077; G06K 19/07

(52) U.S. Cl. CPC G06Q 20/102; G06K 19/07758; G06K 19/0723; H04L 65/1069; G06Q 20/401

(57) ABSTRACT

Methods and systems for processing payments based on remote vehicle identification are provided. This technology requires installation of identification tags, such as RFID tags, on vehicles, which actively or passively emit identification signals conveying vehicle identifiers. When a vehicle arrives on premises of a merchant, a vehicle identifier can be acquired by an electronic device from the vehicle. This allows for verifying the vehicle and obtaining relevant vehicle information. Once the vehicle is identified, the electronic device can cause performing a monetary or non-monetary transaction for goods or services provided by the merchant to the driver or owner of the vehicle. The transaction is performed by a payment processing service deployed on a server in accordance with one or more predetermined rules and against a vehicle owner's account maintained by a database of registered vehicles.

### CROSS-REFERENCE TO RELATED APPLICATIONS

This application is a Continuation-in-Part application of U.S. utility, non-provisional patent application Ser. No. 14/172,025 filed Feb. 4, 2014, entitled “Remote Identification of Vehicle Status” and U.S. utility, non-provisional patent application Ser. No. 14/258,584 filed Apr. 22, 2014, entitled “Parking and Tollgate Payment Processing Based on Vehicle Remote Identification,” which are incorporated herein by reference in their entirety for all purposes.

### TECHNICAL FIELD

This disclosure relates generally to vehicle identification and, more specifically, to the wireless technology for remote identifying of vehicles and processing payments for goods or services based on the result of remote identification.

### DESCRIPTION OF RELATED ART

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Vehicle transportation is one of the basic requirements of modern society, which involves the need for the drivers, owners or passengers of vehicles to make certain purchases while traveling. For example, there is a repetitive need to make purchases of gas at gas stations. Moreover, drivers and passengers often purchase food and drinks, as well certain vehicle-related services such as car wash, oil change, repairs, and the like. Typically, the goods and services are paid by cash or credit cards, however these methods are not necessarily a comfortable way to make payments. Moreover, these payment methods are not secure because cash and credit card data can be stolen at the time of purchase.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Various embodiments of the present disclosure provide methods and systems for effective vehicle identification, which can be utilized in making payments for the goods or services, and also in finding stolen, wanted, or suspicious motor vehicles. Specifically, the present technology involves installation of wireless passive or active identification tags, such as, but not limited to, radio-frequency identification (RFID) tags, Wi-Fi tags, Bluetooth tags, and so forth, on all or certain motor vehicles within a dedicated area such as a country, state, district, or private land or parcel. The identification tag can be configured to emit identification signals, which include a vehicle identifier and, optionally, other information related to the vehicle and/or its owner. The identification signal can be propagated across a relatively short distance, for example, less than 300 feet or even less than 100 feet when the vehicle is in an unassisted view of a human eye.

The present technology may also employ the use of electronic devices, such as a portable computer, tablet computer, wireless telephone, or smart phone, which includes a reader or antenna for wirelessly communicating with the identification tags installed on vehicles. For these ends, the electronic device may run a dedicated software application (e.g., a mobile application) to implement the methods described herein and other processes including communication with the identification tags and remote databases to identify a status of a particular motor vehicle, make reports, issue tickets for traffic or parking violations, process payments, and so forth.

Upon receipt of the identification signals from a vehicle in proximity of the electronic device, the software application can identify a vehicle and related information, and then make a determinative decision for its user as to whether a particular motor vehicle is stolen, wanted, or needs to be monitored in view of specific circumstances. Furthermore, the software application can make a determinative decision as to whether or not a particular identified vehicle is currently moving or parked. The determination of vehicle status can be made by sending requests to one or more servers maintaining a database of vehicle statuses and by analyzing the server's responses. Notably, the remote server(s) may also maintain a database with vehicle registration and/or vehicle related information. Moreover, the remote server(s) may also maintain or be operatively connected to government databases of the same or similar content. The server(s), upon receiving a request from the electronic device, can return vehicle status information (e.g., a stolen status, wanted status, parked status etc.) and, optionally, other vehicle-related information including, for example, vehicle registration information, list of prior offences, incidents, accidents, owner's name, plate number, date of state inspection, vehicle's color, vehicle's year, vehicle identification number, and so forth. The vehicle status may be displayed to the user of the electronic device to prompt the user to take certain actions. The actions may include, without limitation, reporting the location of the stolen vehicle to authorities or to a database maintained by one of the servers, generating a ticket for a traffic or parking violation, reporting about traffic or parking violations, and so forth.

Accordingly, the present technology allows individuals or public authorities to remotely scan and identify vehicles, verify their statuses, and facilitate processing of payments associated with fines, parking, the use of toll roads, and/or traffic or parking violations.

In one aspect of the present disclosure, a method for processing payments based on remote vehicle identification is provided. The method comprises the step of acquiring, by a first electronic device, a vehicle identification signal emitted by a vehicle identification tag secured to a vehicle. The vehicle identification signal conveys a vehicle identifier associated with the vehicle. The first electronic device then sends a first inquiry to a server maintaining a database of registered vehicles. The first inquiry can comprise the vehicle identifier and credentials of a user of the first electronic device.

The method comprises the step of receiving, by the first electronic device, a first response from the server. The first response can include vehicle information. The vehicle information can be generated based on a particular clearance level associated with the user of the first electronic device. The first electronic device then displays the vehicle information. The first electronic device further obtains billing information and sends a billing inquiry to a payment processing service. The billing inquiry comprises the vehicle identifier and the billing information. The billing inquiry causes the payment processing service to perform a monetary or non-monetary transaction based on the billing information and in accordance with one or more predetermined rules and against an account associated with an owner or a driver of the vehicle.

The method further includes obtaining, by the first electronic device, a payment confirmation message from the payment processing service.

In certain embodiments, the vehicle identifier includes a unique code. The unique code can be dynamically changed based on a predetermined rule maintained by the identification tag and the server.

In certain embodiments, the first electronic device is associated with a merchant and second electronic device is associated with the owner or driver of the vehicle.

In certain embodiments, upon receipt of the billing inquiry by the payment processing service, the method further comprising sending, by the payment processing service, a request message to a second electronic device and receiving, by the payment processing service, a confirmation message from the second electronic device. The request message is configured to cause the second electronic device to display the billing information and prompt the owner or the driver of the vehicle to confirm the billing information by making an input. The confirmation message conveys a confirmation of the billing information.

In certain embodiments, upon receipt of the billing inquiry by the payment processing service, the method further comprises sending, by the payment processing service, a request message to the first electronic device and receiving, by the payment processing service, a confirmation message from the first electronic device. The request message is configured to cause the first electronic device to display the billing information and prompt the owner or the driver of the vehicle to confirm the billing information by making an input via the first electronic device. The confirmation message conveys a confirmation of the billing information.

In certain embodiments, the method further comprises acquiring, by the first electronic device, a merchant identification signal emitted by a merchant identification tag secured on premises of a merchant. The merchant identification signal conveys a merchant identifier associated with the merchant. The first electronic device sends a second inquiry to the server, where the second inquiry comprises the merchant identifier. And the first electronic device receives a second response from the server, where the second response comprises an authorization message, which enables the first electronic device to generate the billing inquiry. In certain embodiments, the billing inquiry further comprises the merchant identifier.

In certain embodiments, the method further comprises acquiring, by the first electronic device, a merchant identification signal emitted by a merchant identification tag secured on premises of a merchant, where the merchant identification signal conveys a merchant identifier associated with the merchant, and incorporating the merchant identifier into the billing inquiry.

In certain embodiments, the method further comprises displaying, by the first electronic device, a user interface prompting the owner or the driver of the vehicle to input a code, receiving, by the first electronic device, the code inputted by the owner or the driver of the vehicle, and verifying the code by the first electronic device and through the payment processing service and at least one of the server or an additional server.

In certain embodiments, the method further comprises acquiring, by a video service, a video stream from premises of a merchant associated with the first electronic device, associating, by the video service, the video stream with the monetary transaction, the vehicle identifier, and the owner or the driver of the vehicle.

In certain embodiments, the method further comprises transmitting, by the payment processing service, the payment confirmation message to a second electronic device. The payment confirmation message can comprise a date, time, and charge amount associated with the monetary transaction.

In further example embodiments, steps of methods described herein may be stored on a computer readable storage medium having program instructions embodied thereon, with the program instructions executable by a processor in a computing device. In yet further exemplary embodiments, a system, modules, subsystems, or devices can be adapted to perform the method steps. Other features and exemplary embodiments will be evident from the detailed description provided below.

### BRIEF DESCRIPTION OF DRAWINGS

Embodiments are illustrated by way of example and not limitation in the figures of the accompanying drawings, in which like references indicate similar elements and in which:

FIG. 1A shows a high-level block diagram illustrating a system environment within which methods for vehicle identification may be implemented.

FIG. 1B shows a high-level block diagram illustrating a system environment within which methods for vehicle identification and processing payments may be implemented.

FIG. 2 is a diagrammatic representation of an example electronic device in the form of a computer system within which a set of instructions for the electronic device to perform any one or more of the methodologies discussed herein is executed.

FIG. 3 shows a high-level process flow diagram of a method for vehicle identification according to methodologies discussed herein.

FIGS. 4-10 illustrate schematic diagrams of various graphical user interfaces (GUIs) displayable by an electronic device at different stages of vehicle status identification, according to embodiments of the present disclosure.

FIG. 11 shows an exemplary data structure of database of registered vehicles.

FIG. 12 shows a flow diagram if an example method for processing payments based on remote vehicle identification.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors, controllers or other specially designed application-specific integrated circuits (ASICs), programmable logic devices, or various combinations thereof. In particular, the methods described herein may be implemented by a series of computer-executable instructions residing on a storage medium such as a disk drive, solid-state drive or on a computer-readable medium.

In general, embodiments of the present disclosure implement a technology for vehicle identification and, more specifically, identification of a vehicle status. The technology involves installation of identification tags on vehicles, which can actively or passively emit identification signals conveying vehicle identifiers and, optionally, other information. A user such as a member of the public or an interested party, such as a sale personnel, police officer or parking officer, can be equipped with an electronic device suitable for receiving identification signals from the device installed on the vehicle and process the signals in order to identify the vehicle's status. The vehicle status can be indicative of whether a particular vehicle is stolen, wanted, associated with specific criminal offences, or if a vehicle is parked, on travel, unlisted (i.e., a fake signal), pass, and so forth. The vehicle status can be obtained by querying remote databases maintained by at least one server. Once the vehicle status is determined, it can be displayed or presented to the member of the public or other interested parties in various ways (e.g., on a display of the electronic device or by an audio signal).

The present technology can also enable its users to make reports when, for example, the member of the public or another interested party finds a vehicle not emitting an identification signal. Lack of this signal may be interpreted as illegal removal of identification tags from a vehicle. The user can visually identify the non-emitting vehicle since the device displays a description of the nearby vehicles. The vehicle not emitting any signal is not on the list. Another way to identify a non-emitting vehicle is by counting vehicles either manually or with the help of specific hardware. To these ends, the electronic device may enable its user to generate and send an electronic message to the server or relevant authorities including an identification of the location where a suspicious vehicle is located, a photo of a vehicle, and other related information or commentaries.

Accordingly, provided all vehicles within a specific area, such as a nation, country, state, city, district, or otherwise enclosed area, such as a private land or premises, are equipped with the identification tags, the present technology allows efficient detection of vehicle statuses. It is a very convenient and straightforward technology for use by the general public, merchants, government officials, military and police officers, and other authorities. The vehicle status may not only include information indicative of a particular vehicle being stolen or wanted, but also indicate whether any fines or warrants are outstanding, whether the vehicle passed a required inspection, whether the vehicle is associated with any civil or criminal offences, and so forth. Users will have access to information according to their level of clearance.

It is also important that, in certain embodiments, vehicle owners can themselves set vehicle statuses in the database. For example, the vehicle owners may set the vehicle status to “parked” when they park their vehicles. In other embodiments, the vehicle owners may set the vehicle status to “on travel” to designate that their intention is to remove a stopped vehicle from a dedicated area within a short period of time. Accordingly, this technology makes it impossible to take advantage of stealing identification tags from parked vehicles and placing them on stolen vehicles. The present technology allows citizens to determine whether vehicles they own have any outstanding fines, the date of their next vehicle service, permits associated with the vehicle, such as tinted windows, and so forth.

Furthermore, some embodiments of the present technology allow spotting attempts to duplicate identification tags. This “Chinese wall” option provides for interaction between a database of stolen vehicles and a database of vehicle information based upon analysis of vehicle location data and corresponding vehicle identifiers. More specifically, in an example embodiment, an individual may request information concerning a particular vehicle within a distance range using his electronic device. For these ends, the electronic device acquires a vehicle identifier associated with the vehicle of interest and sends a request to a remote server. This request includes the vehicle identifier and a current location of the electronic device. Another server, which maintains vehicle data, such as location obtained directly from the vehicle in question, compares location data obtained from two independent sources and makes a determination as to whether the identification tag pertaining to the vehicle in question is duplicated. This analysis may also compare a time and date when location information was obtained and, optionally, other related information.

Notably, the present technology can serve as an instrument for obtaining information in a way not infringing on citizens” privacy rights, constitutional rights, or any other applicable laws. In some embodiments, the technology provides various clearance levels for the users of the technology. Specifically, there may be provided one clearance level for the general public, another clearance level for merchants, yet another clearance level for security firms, yet another clearance level for police officers and government officials, and so forth. In one example embodiment, the technology may provide the general public with the lowest clearance level, which means they may not need to use credentials to access certain types of information from third parties, such as basic vehicle description and display of status. Accordingly, the general public may have some limitations as to what information can be delivered to them through the use of the present technology. On the other hand, a higher level of clearance may be given to authorities or police officers meaning they need to have credentials to access and run the methods and functionalities as described herein. In return, the police officers may have access to information without any limitations or with fewer limitations. In some embodiments, access to the methods and functionalities of the present technology may require prior user authentication and authorization, for example, based upon biometric information (e.g., fingerprints, retina or iris images, face images) or a two-step authorization technique.

One aspect of the present technology relates to the maintaining of online services for storing vehicle related information. More specifically, there are provided one or more web servers, which have a first database of vehicle statuses and a second database of registered vehicles. The first database includes merely vehicle statuses (i.e., a stolen status, wanted status, parked status, in-travel status, etc.), while the second database includes vehicle registration data, vehicle description data, user comments associated with various vehicles, and so forth.

At least one of these databases is a “crowdsourcing” data collection meaning that the content stored in the database is solicited by contributions from a large group of people—online community or general public—rather than from traditional employees or suppliers. However, in some embodiments, the databases may relate to government databases or proprietary databases maintained by a limited number of people. In either case, the databases are tamper proof through the use of private and public keys, encryption, cryptography, challenge response mechanisms, and tracking of quota and asynchronous calls, among other mechanisms. Accordingly, the insertion of new vehicles into the databases is a safe process as long as the above security mechanisms are implemented.

Furthermore, some aspects of the instant technology provides for mechanisms for processing payments, for example, associated with purchases of certain goods or services. For these ends, the database of registered vehicles maintains records and/or accounts for a plurality of vehicles. Each of the records/accounts can be associated with a particular vehicle owner (or driver) and may maintain payment details such as credit card details, banking account details, and billing address, as well as other information such as the vehicle owner's personal information, mailing address, contact information, photograph, and so forth. In some embodiments, the vehicle owners may have access to the database of registered vehicles to allow them to create and/or edit their respective accounts for each registered vehicle (for example, through a website or mobile application and based on a clearance level).

Therefore, the present technology enables processing payments using the payment details stored in the database of registered vehicles and also based on predetermined rules. The payments can include monetary transactions and non-monetary transactions. Monetary transactions can include transactions involving an official currency such as U.S. dollars. Non-monetary transactions can include transactions involving virtual points (e.g., “miles” or “rewards”).

The processing of payments can be initiated by merchants after reading or scanning identification tags secured to vehicles. For example, when a vehicle arrives to a gas station to make a purchase of gas, an employee of the gas station can make a reading of the identification tag secured to the vehicle by an employee electronic device. As a result of reading, the employee electronic device receives a vehicle identifier from the identification tag and sends an inquiry to a server maintaining the database of registered vehicles. The server can pull out predetermined vehicle information in response to the inquiry. The server then delivers the predetermined vehicle information to the employee electronic device. The predetermined vehicle information can include vehicle identification information, including, but not limited to, a make and model of the vehicle, production year, color, license plate, vehicle identification number, vehicle repair or maintenance data or requirements, and the like. The predetermined vehicle information can also include information about an owner or driver associated with the vehicle, for example, a name, photograph, address, contact information, phone number, email, and the like. The predetermined vehicle information can be customized as to what information specifically is to be delivered to the employee electronic device.

Further, the employee can greet the driver (owner) of the vehicle by name after reading the predetermined vehicle information received from the server and ask for driver's needs. The driver (owner) of the vehicle can ask the employee to make certain purchases of goods or services. For example, the driver can purchase gas for the vehicle. In response to the driver's request, the employee can initiate a monetary transaction using his employee electronic device right before or after the requested goods or services are provided to the driver (owner). For these ends, the employee generates or enters billing information to the employee electronic device. The billing information can include data about goods or services to be purchased (e.g., goods/services codes) and optionally amount of goods or services to be purchased, price of goods or services to be purchased, and any other information required for the transaction. In some embodiments, the data about goods or services to be purchased can be automatically incorporated into the billing information by reading bar codes or QR-codes.

The employee electronic device generates a billing inquiry based on the billing information and sends the billing inquiry to a server maintaining a payment processing service. The billing inquiry can also include the vehicle identifier as obtained from the identification tag. In some embodiments, for security purposes, the billing inquiry can optionally include a merchant (point of sale) identifier, which can be acquired from a merchant identification tag secured on premises of the merchant. This option eliminates a potential problem of when the employee electronic device is used without merchant authorization anywhere beyond the merchant premises.

The payment processing service receives and processes the billing inquiry. Specifically, the payment processing service makes a monetary or non-monetary transaction based on the billing information against an account of the vehicle driver (owner), which is identified using the vehicle identifier. For example, the payment processing service can process or cause processing a credit card stored in the account of the driver to transfer money from the driver to the merchant as a consideration for the goods or services provided by the merchant.

In some embodiments, there can be employed a process of authorization of the transaction, which optionally can be a two-step authorization process. In one example embodiment, the payment processing service can cause the employee electronic device to display a user interface prompting the driver (or owner) to input a code, such as a personal identification number (PIN) code, alpha-numeric code, or provide any appropriate biometric data (e.g., perform fingerprint reading, retina reading, etc.). When received, the code or biometric data is validated by matching the code or biometric data to records of the server. Upon successful validation of the code or biometric data, the payment processing service can proceed with the transaction.

In another example embodiment, the payment processing service can cause a driver electronic device to confirm or validate the transaction. In this regard, the payment processing service can cause the driver electronic device to display a user interface including at least a part of the billing information and means for accepting or denying the transaction. For example, there can be displayed the goods or services to be purchased, price and optionally other information. The driver (owner) can click a button via the user interface indicating his acceptance or rejection of the transaction. In some embodiments, the driver (owner) may need to enter a PIN code, alpha-numeric code, or provide biometric data through the driver electronic device to enable the payment processing service validating the transaction when the PIN code, alpha-numeric code, or biometric data matches records in the account associated with the driver (owner) of the vehicle.

Upon successful completion of the transaction, the payment processing service sends a payment confirmation message to the employee electronic device and/or to the driver electronic device. The payment confirmation message can be displayed on the respective electronic device. Furthermore, upon successful completion of the transaction, the payment processing service can make a transaction log or record in a database in association with the account of the merchant and the account of the driver (owner). Thus, both the merchant and the driver (owner) can review past transactions in their respective accounts.

In some additional embodiments, once the transaction is completed for a particular vehicle, the vehicle driver (owner) can be notified about the transaction by an e-mail, text message, voice message, push notification, or any other suitable communication to the driver electronic device such as a cellular phone or computer.

In some embodiments, the transactions can be initiated automatically. For example, when a vehicle moves near an electronic device installed on premises of the merchant (e.g., when a vehicle stops near a gas pump, which is equipped with an electronic device configured to read identification tags, and after the driver uses the gas pump to dispense gas to his vehicle).

Yet another security measure in this technology is the use of video cameras on premises of the merchant. The video cameras can capture video stream, which is stored on a server. The video stream can be fragmented and each of the fragments can be associated with a particular transaction performed by the payment processing service, the employee, the driver (owner), and/or the vehicle. The video stream can have a time and date stamp and optionally a location tag. Thus, in case of a transaction dispute, the merchant would be able to pull out a particular video fragment associated with the disputed transaction to verify whether or not the driver (owner) received the goods or services associated with the disputed transaction.

Thus, the present technology allows significantly decreasing vehicle theft rates and increasing the rates of stolen vehicle recovery. In addition, it provides an easy to use mobile application or specific hardware with limited clearance for the general public that attracts a great number of people to be a part of a nation-wide vehicle security system. Furthermore, the present technology allows easy processing of payments associated with exchange of goods or services for money at merchants or point of sales. Provided below is a detailed description of various embodiments with reference to accompanying drawings.

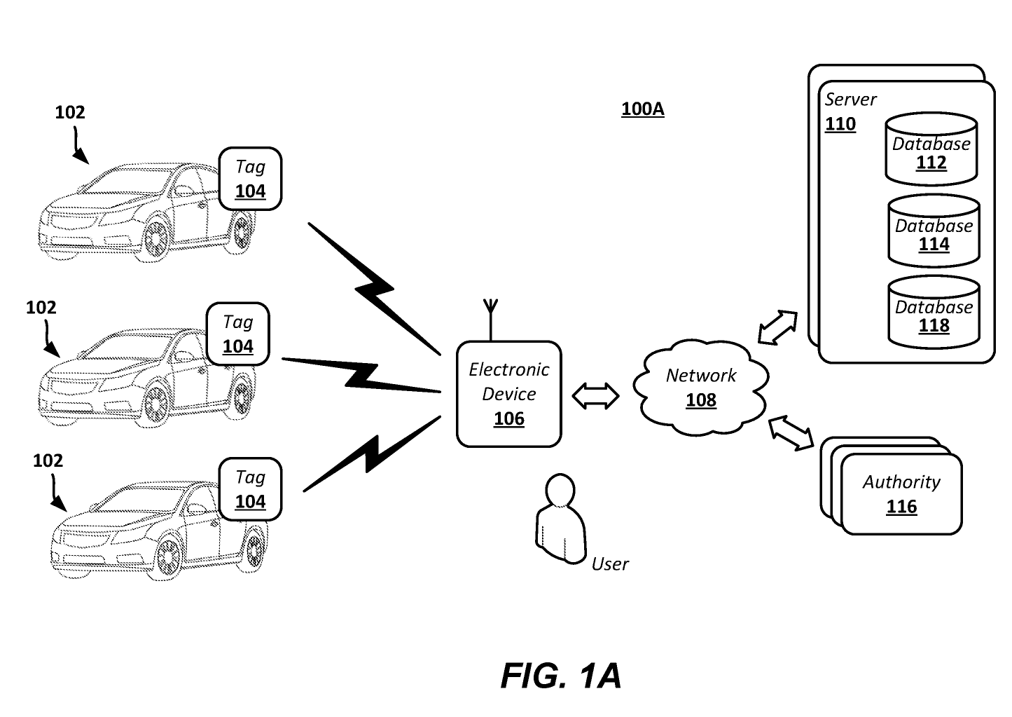

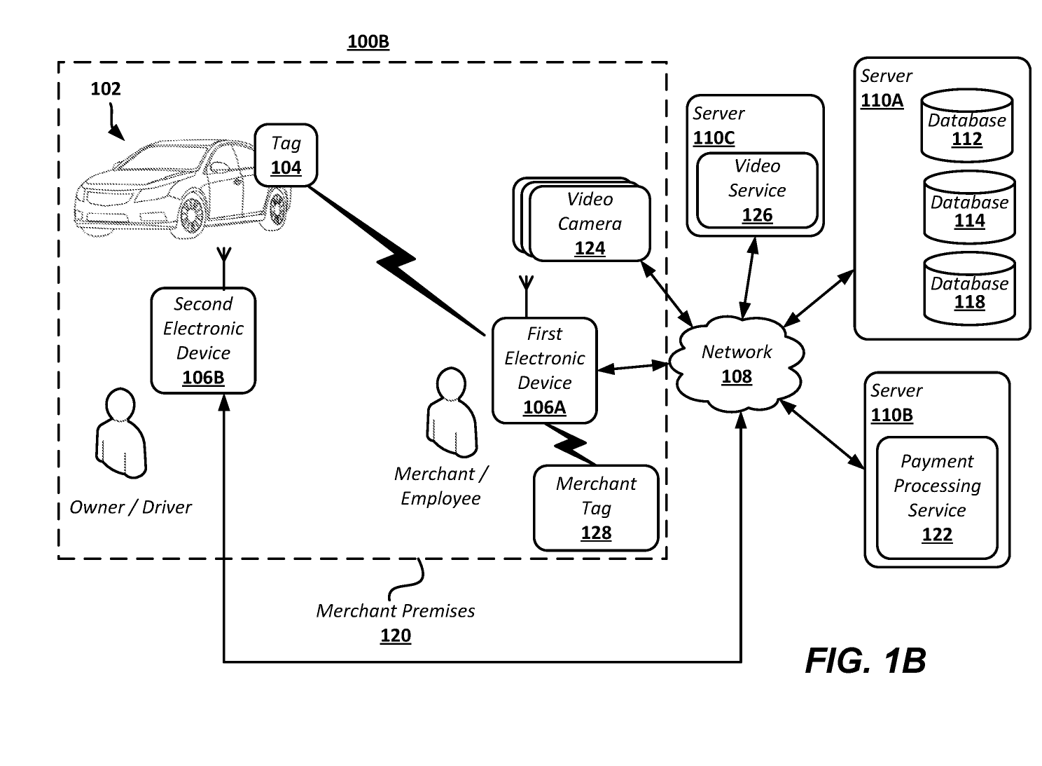

FIG. 1A shows a high-level block diagram illustrating a system environment 100A within which methods for vehicle identification and payment processing may be implemented, in accordance with an example embodiment. In particular, there are shown a number of motor vehicles 102, each of which is equipped with an identification tag 104. The terms “vehicle” or “motor vehicle,” as used herein, refer to any machine suitable for transferring passengers or cargo; this may include, without limitation, automobiles, cars, trucks, buses, motorcycles, bicycles, trains, ships, boats, watercrafts, and aircraft.

The identification tags 104 may include, for example, RFID tags, labels, or transponders, as well as wireless transmitters, portable communication devices, Wi-Fi emitter tags, Bluetooth emitter tags, and so forth. In case of RFID tags, the identification tags 104 may be of passive or active types. Passive identification tags 104 are powered by and read at short ranges via magnetic fields so that they emit electromagnetic waves conveying certain information. In other words, the passive identification tag 104, when powered, emits an identification signal. Active identification tags 104 are powered by a local power source, such as a battery, and repeatedly emit an identification signal.

According to various embodiments, the identification signal includes at least a vehicle identifier (vehicle identifier refers, for example, to a unique alphanumeric code). In certain embodiments, the identification signal may also include other information such as a plate number and vehicle registration data, among other things. In some embodiments, the vehicle identifier can include a unique code which is dynamically changed based on a predetermined principle, which prevents misappropriation of vehicle identifier for crime purposes. The predetermined principle for changing the unique code can be known to the identification tag 104 and a server maintaining a database of registered vehicles. In some embodiments, however, the identification tag 104 can have a receiver, such as a receiver of signals transmitted by a satellite-based communication system. The receiver of identification tag 104 can dynamically receive unique codes so that these unique codes match with codes stored by the server maintaining the database of registered vehicles.

It should be also noted that the identification tags 104 emit identification signals with a limited short-range area. In some examples, the area of identification signal propagation is limited to 300 feet, although it is limited to 100 feet or even less in other example embodiments. The identification tags 104 are secured to the vehicles 102 in designated places. In one example, the tags 104 can be attached to or be an integral part of a license plate or a windshield sticker.

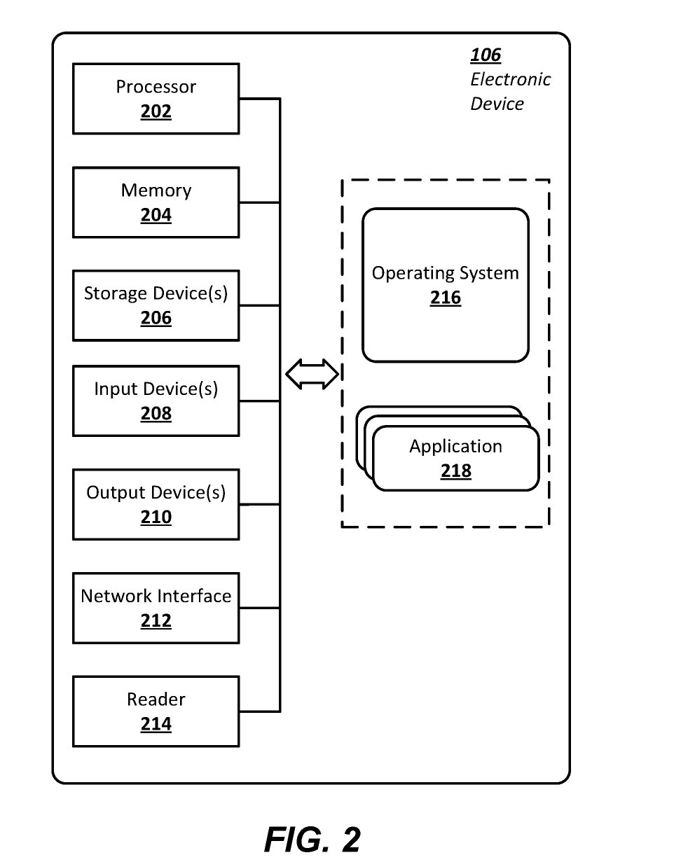

Still referencing to FIG. 1A, there is provided an electronic device 106, which may refer, without limitation, to a portable computing device, tablet computer, laptop computer, general-purpose computer, netbook, mobile phone, smart phone, personal digital assistant (PDA), video recording system, and surveillance system, among others. The electronic device 106 is further described below and shown in FIG. 2. The electronic device 106 may be in possession of an individual (user), such as an employee of merchant. In other embodiments, the electronic device 106 may be an integral part of a parking meter or a tollgate.

In general, the electronic device 106 is configured to wirelessly communicate with the identification tags 104. This may include powering and activating passive identification tags 104 by emitting electromagnetic waves and receiving responses from identification tags (i.e., identification signals). In other example embodiments, the electronic device 106 passively aggregates identification signals from active identification tags 104.

Upon receipt of the identification signals from the identification tags 104, the electronic device 106 processes them to retrieve vehicle identifiers associated with the vehicles 102. Further, the vehicle identifiers are used to obtain vehicle status data. In one example, the electronic device 106 inquires its own database of vehicle statuses (not shown) with the vehicle identifiers to determine if one of the vehicles 102 is stolen or wanted, or to retrieve vehicle registration data or related information. In another example, the electronic device 106 inquires, via a communication network 108, a server 110. The server 110 maintains a database, such as a database 112 of vehicle statuses, although the server 110 can maintain other databases including, but not limited to, a database 114 of registered vehicles containing vehicle registration data, state inspection data, information associated with outstanding fines or tickets, prior offences or traffic violation data, vehicle owner accounts, or a combination thereof. In some embodiments, the server 110 maintains a parking database 118 which includes a list of parking spot statuses. In some embodiments, the servers run crowdsourcing software to allow the general public to solicit content of the databases 112, 114, 118. In some other embodiments, the server 110 may include, be an integral part of, or in some other way be associated with the National Motor Vehicle Title Information System (NMVTIS), National Crime Information Center (NCIC), and Driver and Vehicle Licensing Agency (DVLA), among others.

In either case, the server 110 acquires the vehicle identification from the electronic device 106 and sends back a response conveying a partial record stored in the database 112 of vehicle statuses and optionally records from other databases such as the database 114. In a most simple case, the response contains a vehicle status like “Pass” or “Fail,” which may be coded in a single bit message element. In other words, the response includes information as to whether or not a particular vehicle 102 is listed in the database 112 of vehicle statuses. Thus, the electronic device 106 determines, based upon the server's response, the vehicle status and may display it on its screen, generate an alert audio or video message, generate a report, and the like. The user of the electronic device 106 may report the vehicle status to one or more of authorities 116 in certain cases, such as when a stolen vehicle is identified. Authorities 116 refers, without limitation, to a police department, Federal Bureau of Investigation (FBI), private security provider or firm, military, NMVTIS, NCIC, DVLA, or a combination thereof.

FIG. 1B shows a high-level block diagram illustrating a system environment 100B within which methods for vehicle identification and payment processing may be implemented, in accordance with another example embodiment. The environment 100B involves a merchant. The merchant shall mean a gas station, store, dealer, vending machine, system, cashier's desk, check-out counter, point-of-purchase or other outlet where goods or services are sold.

A vehicle 102, which is equipped with an identification tag 104, can visit premises 120 of the merchant. The term “premises” shall mean a predetermined geographical area, location, or at least a part of building associated with a merchant. The identification tags 104 of vehicles 102 may include, for example, RFID tags, labels, or transponders, as well as wireless transmitters, portable communication devices, Wi-Fi emitter tags, Bluetooth emitter tags, and so forth. In case of RFID tags, the identification tags 104 may be of passive or active types. Passive identification tags 104 are powered by and read at short ranges via magnetic fields so that they emit electromagnetic waves conveying certain information. In other words, the passive identification tag 104, when powered, emits an identification signal. Active identification tags 104 are powered by a local power source, such as a battery, and repeatedly emit an identification signal.

The merchant can be associated with one or more electronic devices. For example, one or more employees, officers or agents of the merchant can use a first electronic device 106A, which may refer, without limitation, to a portable computing device, tablet computer, laptop computer, general-purpose computer, netbook, mobile phone, smart phone, PDA, and the like. The electronic device 106A is configured to scan and read radio signals emitted by the identification tags 104. In some embodiments, the first electronic device 106A is configured to wirelessly communicate with the identification tags 104. This may include powering and activating passive identification tags 104 by emitting electromagnetic waves and receiving responses from identification tags (i.e., identification signals). In other example embodiments, the first electronic device 106A passively aggregates identification signals from active identification tags 104.

Upon receipt of the identification signals from the identification tags 104, the first electronic device 106A processes them to retrieve vehicle identifiers associated with the vehicles 102 or their owners/drivers. Further, the first electronic device 106A can make an inquiry, via the communication network 108, to the server 110A. The server 110A maintains a database, such as a database 114 of vehicle statuses, although the server 110A can maintain other databases including, but not limited to, a database 114 of registered vehicles containing vehicle registration data, state inspection data, information associated with outstanding fines or tickets, prior offences or traffic violation data, vehicle owner accounts, or a combination thereof. In some embodiments, the server 110A maintains a parking database 118 which includes a list of parking spot statuses. The database 114 of registered vehicles can also include a plurality of accounts. Each of the accounts can be associated with a particular vehicle 102 and its owner and/or driver. Each of the accounts can include vehicle information (e.g., make and model of vehicle, production year, color, type, vehicle identification number (VIN), etc.), owner personal information (e.g., name, address, photograph, contact information, etc.), driver personal information (e.g., name, address, photograph, contact information, etc.), billing information (e.g., credit card details, billing address, banking information, etc.), and/or records (logs) of past purchases (e.g., past monetary and non-monetary transactions).

Still referring to FIG. 1B, the owner or driver of the vehicle 102 is equipped with a second electronic device 106B. The second electronic device 106B can be the same or an analog of the first electronic device 106A. For example, the second electronic device 106B can be a smart phone, with or without ability to read identification tags 104. The second electronic device 106B can also be in operative communication with the server 110A such that the owner or driver of vehicle 102 can access his account stored in the database 114. For these ends, the second electronic device 106B can have a dedicated mobile (software) application or browser to communicate with server 110A.

Similarly, the merchant can have an account stored in the database 114 or in any other database. The account of the merchant can include merchant personal or business information (e.g., name, address, photograph, contact information, etc.), billing information (e.g., banking information, credit card processor, etc.), and/or records of past monetary and non-monetary transactions. For these ends, the first electronic device 106A can have a dedicated mobile (software) application or browser to communicate with server 110A.

Thus, when the vehicle comes on the premises 120 of the merchant, the first electronic device 106A can obtain the vehicle identifier from the identification tag 104 and make an inquiry to the database 114 to verify the vehicle 102. The inquiry includes the vehicle identifier retrieved from the vehicle identification signal received from the identification tag 104. In response, the database 114 can return to the first electronic device 106A, vehicle information for further display on the first electronic device 106A for attention of the merchant employee. The vehicle information can include one or more of the following: a make of the vehicle, model of vehicle, production year of the vehicle, color of the vehicle, type of the vehicle, VIN of the vehicle, owner personal information (e.g., name, address, photograph, contact information, etc.), driver personal information (e.g., name, address, photograph, contact information, etc.), billing information (e.g., credit card details, billing address, banking information, etc.), and/or records of past purchases (e.g., past monetary and non-monetary transactions of the driver or owner). With this information at hand, the merchant can better service the driver (owner) of the vehicle 102.

The environment 100B also employs a server 110B having a payment processing service 122. In some embodiments, the server 110A can be the same as the server 110B. The payment processing service 122 can be an online payment processing service configured to perform monetary or non-monetary transactions based on billing information provided by the merchant via the first electronic device 106A. The billing information can include data about goods or services to be purchased (e.g., goods/services codes) and optionally amount of goods or services to be purchased, price of goods or services to be purchased, and any other information required for the transaction. In some embodiments, the data about goods or services to be purchased can be automatically incorporated into the billing information by reading bar codes or QR-codes, or by retrieving this information from an internal or remote database. The term “payment processing service” shall mean any device, system or software application configured to perform a transaction by exchanging data with financial institutions, banks or other entities.

The payment processing service 122 can also be in communication with the second electronic device 106B, for example, for purposes of requesting a confirmation of the transaction. Thus, the payment processing service 122 can cause the second electronic device 106B to display a user interface showing at least a part of the billing information and prompting the driver (owner) to confirm the transaction by clicking a button, entering an alphanumeric code, reading a fingerprint, and the like.

In some embodiments, the payment processing service 122 can also be in communication with the first electronic device 106B for purposes of requesting a confirmation of the transaction. In this implementation, the payment processing service 122 can cause the first electronic device 106A to display a user interface showing at least a part of the billing information and prompting the driver or owner of the vehicle (not the merchant) to confirm the transaction by clicking a button, entering an alphanumeric code, reading a fingerprint, and the like.

Still referring to FIG. 1B, the environment 100E also employs one or more digital video cameras 124 for capturing a video stream on the premises 120. The video stream can be recorded by a video service 126 maintained by a server 110C. The video stream can show how the driver (owner) of the vehicle 102 entered the premises 120 and how he was provided with certain goods or services. The server 110C can be the same as the server 110A and/or server 110B. The merchant can later access the video stream stored by the video service 126 for verification purposes. In some embodiments, the video stream can be physically or virtually fragmented such that each fragment can be associated with a particular transaction, driver (owner), vehicle 102, first electronic device 106A, and/or second electronic device 106B.

In some embodiments, the environment 100E also includes one or more merchant identification tags 128. The merchant identification tags 128 can be same or similar to vehicle identification tags 104. The merchant identification tags 128 can be secured on the premises 120 of the merchant. The merchant identification tags 128 can include generate and emit a merchant identification signal that conveys a merchant identifier. The first electronic device 106A can be configured to receive the merchant identification signal and retrieve the merchant identifier for further use.

FIG. 2 is a high-level block diagram illustrating an example electronic device 106 (including the first electronic device 106A and the second electronic device 106B) suitable for implementing methods described herein. In particular, the electronic device 106 may be used for vehicle identification and identification of vehicle status. The electronic device 106 may include, be, or be an integral part of one or more of a variety of types of devices, such as a general-purpose computer, desktop computer, laptop computer, tablet computer, netbook, mobile phone, smartphone, PDA, vehicle computer, infotainment system, security device, and surveillance device, smart television device, among others. Furthermore, the electronic device 106 may be an integrated part of another multi-component system such as a vehicle monitoring systems. In yet more embodiments, the electronic device 106 may be an integrated part of a parking meter or tollgate. Notably, FIG. 2 illustrates just one example of the electronic device 106 and in some embodiments the electronic device 106 may have fewer elements/modules than shown on FIG. 2 or more elements/modules than shown on FIG. 2.

As shown in FIG. 2, the electronic device 106 includes one or more processors 202, a memory 204, one or more storage devices 206, one or more input devices 208, one or more output devices 210, network interface 212, and a reader 214 (e.g., an antenna, interrogator, or reading device for RFID tags 104). One or more processors 202 are, in some examples, configured to implement functionality and/or process instructions for execution within the electronic device 106. For example, the processors 202 may process instructions stored in memory 204 and/or instructions stored on storage devices 206. Such instructions may include components of an operating system 216 or software application(s) 218. Electronic device 106 may also include one or more additional components not shown in FIG. 2, such as a housing, power supply, battery, global positioning system (GPS) receiver, payment module (e.g. credit card reader or coin slot), and so forth.

Memory 204, according to one example, is configured to store information within the electronic device 106 during operation. Memory 204, in some example embodiments, may refer to a non-transitory computer-readable storage medium or a computer-readable storage device. In some examples, memory 204 is a temporary memory, meaning that a primary purpose of memory 204 may not be long-term storage. Memory 204 may also refer to a volatile memory, meaning that memory 204 does not maintain stored contents when memory 204 is not receiving power. Examples of volatile memories include random access memories (RAM), dynamic random access memories (DRAM), static random access memories (SRAM), and other forms of volatile memories known in the art. In some examples, memory 204 is used to store program instructions for execution by the processors 202. Memory 204, in one example, is used by software (e.g., the operating system 216) or applications 218. Generally, applications 218 refer to software applications suitable for implementing at least some operations of the methods for vehicle identification or processing payments based on remote vehicle identification as described herein.

One or more storage devices 206 can also include one or more transitory or non-transitory computer-readable storage media and/or computer-readable storage devices. In some embodiments, storage devices 206 may be configured to store greater amounts of information than memory 204. Storage devices 206 may further be configured for long-term storage of information. In some examples, the storage devices 206 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Still referencing to FIG. 2, the electronic device 106 may also include one or more input devices 208. The input devices 208 may be configured to receive input from a user through tactile, audio, video, or biometric channels. Examples of input devices 208 may include a keyboard, keypad, mouse, trackball, touchscreen, touchpad, microphone, one or more video cameras, image sensors, fingerprint sensors, or any other device capable of detecting an input from a user or other source, and relaying the input to electronic device 106, or components thereof. Additional examples of input devices 208 include depth sensors, lidars, remote sensors, and so forth. Though shown separately in FIG. 2, the reader 214 may, in some instances, be a part of input devices 208. It should be also noted that the reader 214 may be a peripheral device operatively connected to the electronic device 106 via the network interface 212.

The output devices 210, in some examples, may be configured to provide output to a user through visual or auditory channels. Output devices 210 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. Output devices 210 may also include a touchscreen, presence-sensitive display, or other input/output capable displays known in the art.

The electronic device 106, in some example embodiments, also includes network interface 212. The network interface 212 can be utilized to communicate with external devices via one or more networks such as one or more wired, wireless, or optical networks including, for example, the Internet, intranet, local area network (LAN), wide area network (WAN), cellular phone networks (e.g. Global System for Mobile (GSM) communications network, packet switching communications network, circuit switching communications network), Bluetooth radio, and an IEEE 802.11-based radio frequency network, among others. The network interface 212 may be a network interface card, such as an Ethernet card, an optical transceiver, a radio frequency transceiver, or any other type of device that can send and receive information. Other examples of such network interfaces may include Bluetooth®, 3G, 4G, LTE, and Wi-Fi radios in mobile computing devices.

The operating system 216 may control one or more functionalities of electronic device 106 and/or components thereof. For example, the operating system 216 may interact with the applications 218 and may facilitate one or more interactions between the applications 218 and one or more of processors 202, memory 204, storage devices 206, input devices 208, and output devices 210. As shown in FIG. 2, the operating system 216 may interact with or be otherwise coupled to the application(s) 218 and components thereof. In some embodiments, application(s) 218 may be included in operating system 216. In these and other examples, virtual modules, firmware, or software for vehicle identification may be part of the applications 218. In other examples, virtual modules, firmware, or software for vehicle identification may be implemented externally to electronic device 106, such as at a network location. In some such instances, electronic device 106 may use the network interface 212 to access and implement functionalities provided by virtual modules, firmware, or software for vehicle identification through methods commonly known as “cloud computing.”

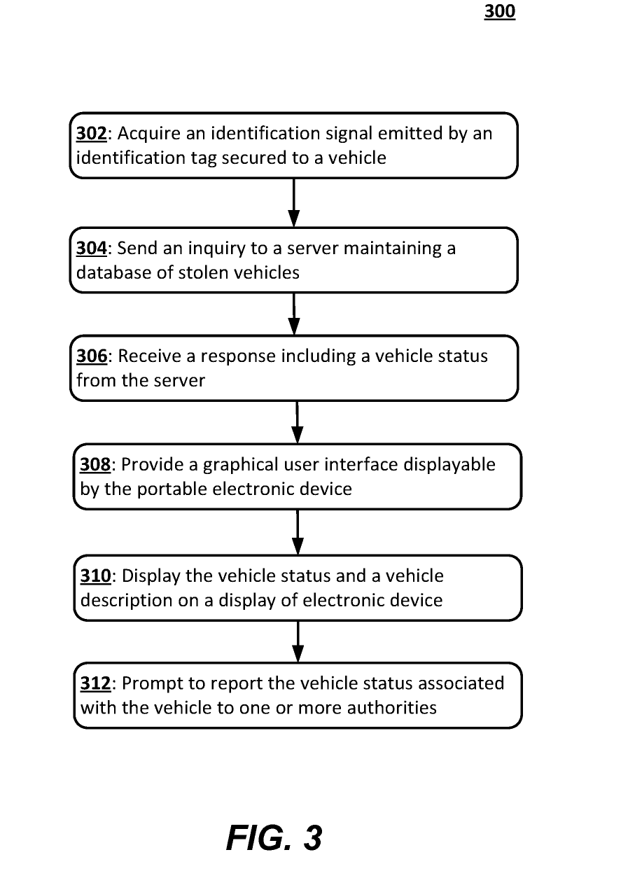

FIG. 3 shows a high-level process flow diagram of a method 300 for vehicle identification according to one exemplary embodiment. The method 300 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 300 is implemented by the electronic device 106 shown in FIGS. 1A, 1B and 2; however, it should be appreciated that the method 300 is just one example operation of the electronic device 106. In addition, the below recited steps of the method 300 may be implemented in an order different than described and shown in FIG. 3. Moreover, the method 300 may have additional steps not shown herein, but which can be evident for those skilled in the art from the present disclosure. The method 300 may also have fewer steps than outlined below and shown in FIG. 3.

The method 300 commences at step 302 with the electronic device 106 acquiring an identification signal emitted by an identification tag 104 secured to a motor vehicle 102. As described above, the identification signal conveys a vehicle identifier in the form of alphanumeric code or base 64 encoding. Optionally, the identification signal further includes additional information such as vehicle registration information, and/or plate number, among other things. At step 304, the electronic device 106 sends an inquiry to the server 110, which maintains a database such as the database 112 of vehicle statuses. The inquiry may simply contain the vehicle identifier retrieved from the identification signal and, optionally, other data. In some embodiments, the same or similar inquiry can be sent to the database 114 of registered vehicles to obtain additional information associated with the vehicle in question. At step 306, the electronic device 106 receives a response from the server 110 with a vehicle status from the database 112 with a basic description of the vehicle and optionally, according to clearance levels, additional data such as vehicle registration information, list of outstanding fines or tickets, list of offences associated with the vehicle 102 or a combination thereof, from the database 114. The vehicle status bears the information as to whether the vehicle 102 is stolen, wanted, suspicious, subject for inspection in view of other reasons, parked, and so forth. Thus, the electronic device 106 determines whether the vehicle 102 is listed in the database 112 of vehicle statuses. If the vehicle 102 is listed, then the electronic device 106 determines whether the status is pass or fail. If the vehicle 102 is not listed, the signal emitted is considered an altered signal and is reported as an invalid vehicle identifier (VID).

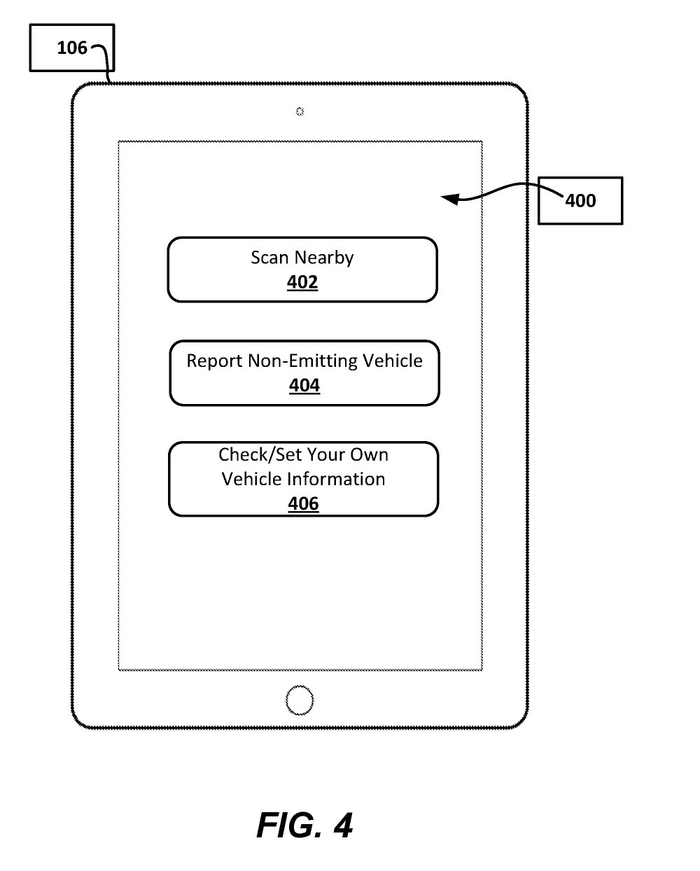

Further, at step 308, the electronic device 106 provides a GUI and displays it on a display of the electronic device 106. Exemplary GUIs are discussed below with reference to FIGS. 4-10. At step 310, the electronic device 106 displays, through the GUI, the vehicle status for attention of the user and optionally other information associated with the vehicle. At step 312, the electronic device 106 prompts the user to report the vehicle status to one of the authorities 116. The reporting includes sending an electronic message or alert via the network 108.

FIGS. 4-10 illustrate schematic diagrams of GUIs displayable by the electronic device 106 at different stages of vehicle status identification. As shown in these drawings, the electronic device 106 is a tablet computer; however, the same or similar GUIs may be provided for other types of electronic devices 106 such as desktop or laptop computers, cellular telephones, and so forth.

FIG. 4 shows a GUI 400 displayable at the time of activation of an application 218 for vehicle identification. In an example embodiment, the interface 400 includes actionable messages (buttons) or hyperlinks. Namely, these are “Scan Nearby” button 402 and “Report Non-Emitting Vehicle” button 404. When the user presses the button 402, the method 300 is activated and similarly, by pressing the button 404, at least some steps of a method for reporting non-emitting vehicles are implemented. “Check/Set Your Own Vehicle Information” button 406 allows the user with login credentials to check and set information of vehicles the user owns.

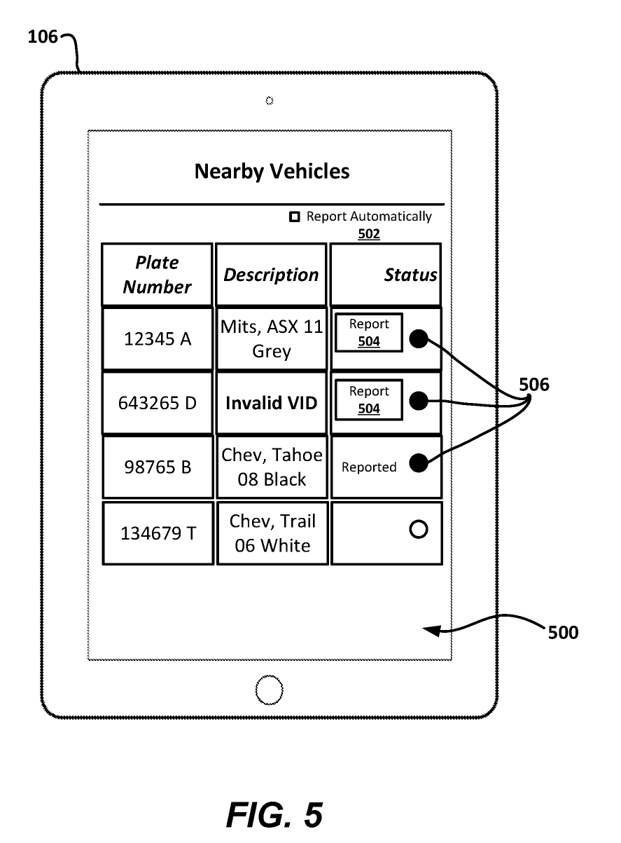

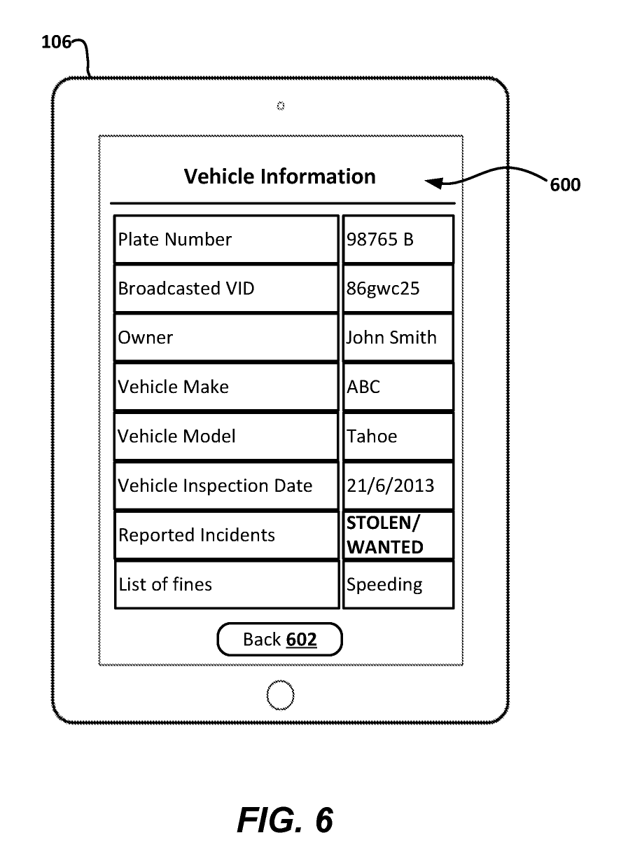

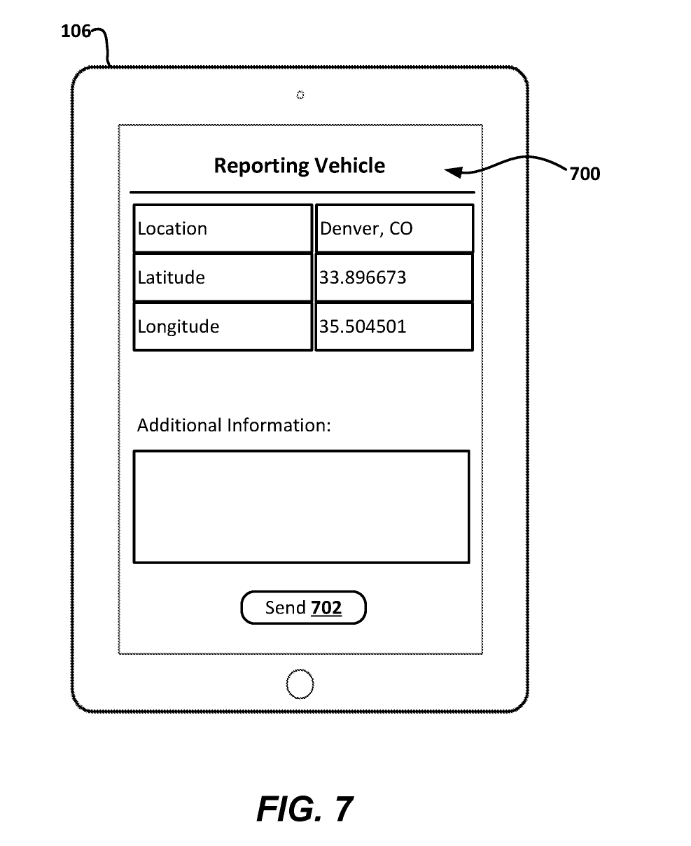

FIG. 5 shows a GUI 500 displayable in response to a press of the button 402. In particular, the GUI 500 shows the results of the method 300 for vehicle identification, which includes a tray (output box) where a table is presented. The table shows vehicle plate numbers of located vehicles, basic descriptions of vehicles, and vehicle statuses as acquired from the server. As shown in the figure, one of the table string lists “Invalid VID” meaning that the vehicle with the plate number “643265 D” is emitting a VID that is not listed in the database of vehicle statuses and thus requires special attention by competent authorities. One of the table strings lists a vehicle with a black dot 506 and plate number “12345 A” meaning that the vehicle with plate number “12345 A” is listed in the database with a Wanted/Stolen status reflected on the interface by the black dot 506. A “Report” button 504 can be used by the user in order to report the vehicle on the same row of the table of the GUI 700 shown on FIG. 7. As shown on FIG. 5, the vehicle with plate number “98765 B” with the black dot 506 has already been reported by the user of device 106. A “Report Automatically” button 502 can be used by the user of device 106 to choose for the device 106 to report automatically about suspicious vehicles that are within the range area. Each string in the table may be actionable according to levels of clearance. For example, upon the user pressing on the line showing “987265 D” as a plate number, the GUI is replaced with a GUI 600 shown in FIG. 6.

As illustrated in FIG. 6, the GUI 600 contains a table with detailed information regarding the selected vehicle 102. This GUI is reached only by users with proper clearance levels. The information may include, but is not limited to, vehicle registration data, plate number, owner's name, date of last state inspection, vehicle make, vehicle model, vehicle color, vehicle year, vehicle's representable image, list of reported incidents or accidents, list of offences associated with the vehicle or vehicle's owner, or a combination thereof. The GUI 600 also includes one actionable button: a “Back” button 602 to return to the previous GUI 500.

FIG. 7 shows a GUI 700 displayable in response to the press of the button 504 shown on FIG. 5. FIG. 7 illustrates the GUI 700 suitable for reporting to one or more authorities 116. The GUI 700 includes a tray showing multiple fields with information subject for inclusion into a report. This may include, but is not limited to, location information, plate number, vehicle identifier, vehicle registration data, and additional information. Upon the user pressing a “Send” button 702, the electronic device 106 transmits the report to one or more of the authorities 116.

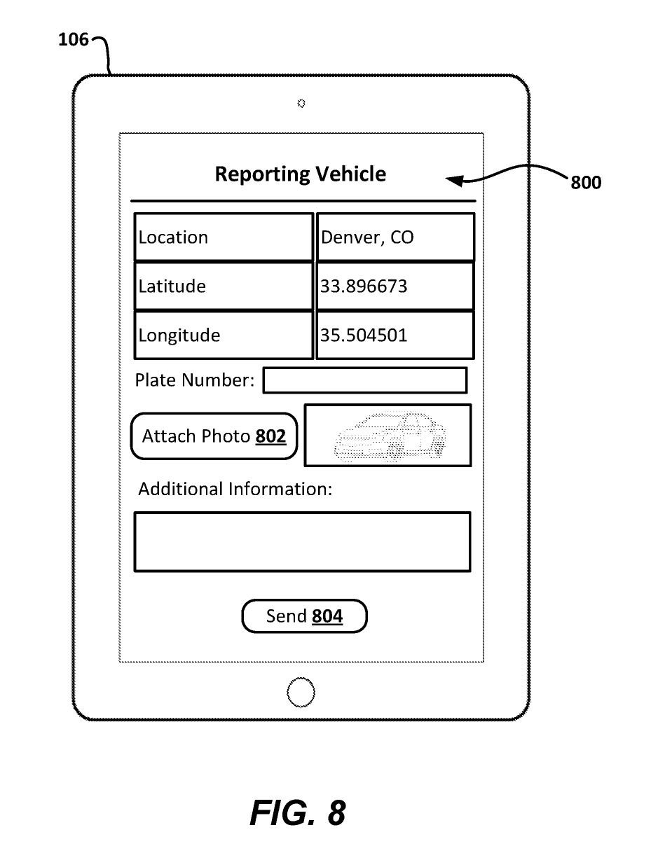

FIG. 8 shows a GUI 800 displayable in response to the press of the button 404. In particular, the GUI 800 relates to a method of reporting to the authorities 116 when a suspicious vehicle is identified by the user as not emitting any signal. Similar to FIG. 7, the GUI 800 shown in FIG. 8 has a tray for showing what information will be included or subject to inclusion in a report message. This includes, without limitation, location information, vehicle registration data (if available), plate number (which can be input by the user), a photo of the suspect vehicle (which can be added by the user when an “Attach Photo” button 802 is activated), and additional information (as can be input by the user). Upon the user pressing a “Send” button 804, the electronic device 106 transmits the report to the one or more of the authorities 116.

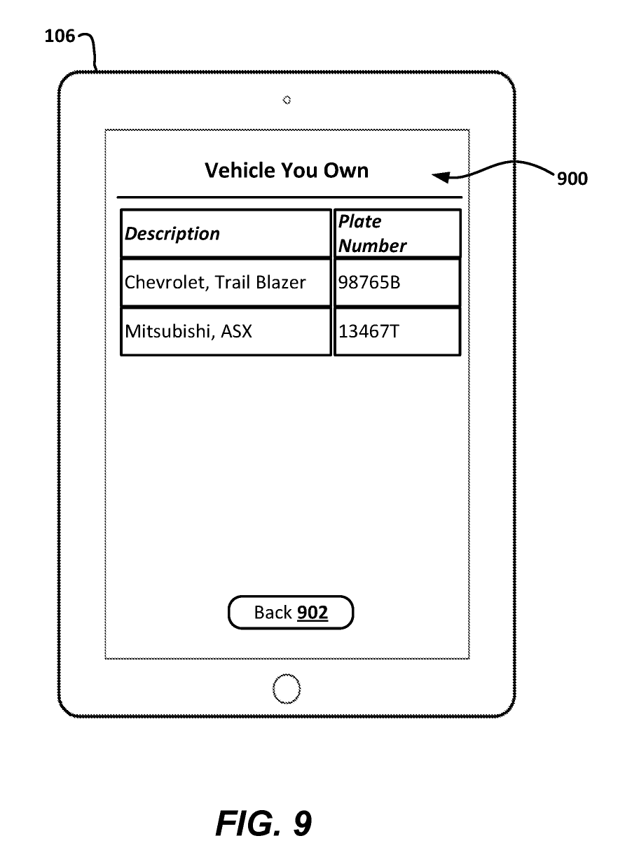

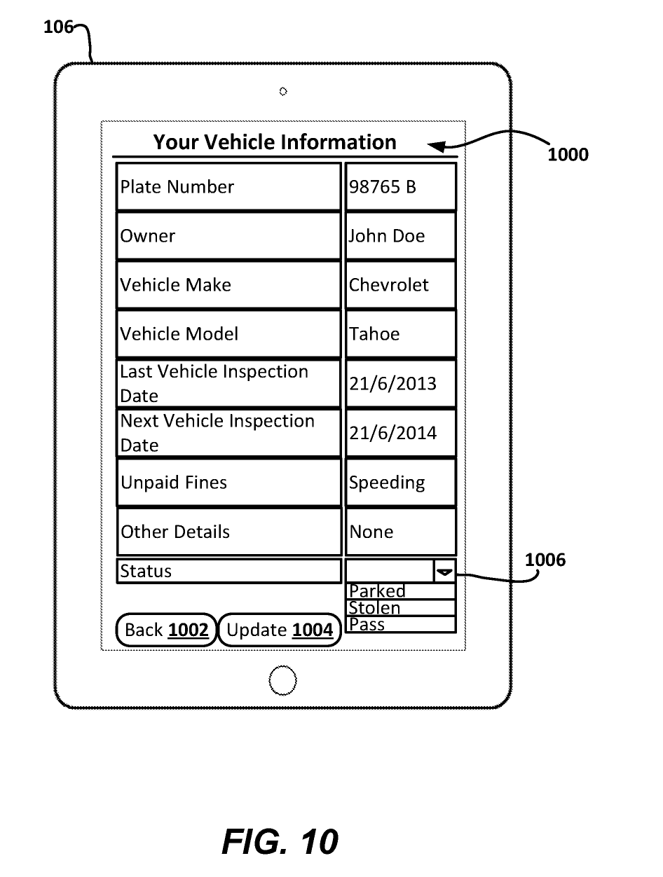

FIG. 9 shows a GUI 900 displayable in response to the press of the button 406 shown on FIG. 4. The GUI 900 displays a list of vehicles owned by the user currently logged into the system with specific secure credentials. The GUI 900 displays a table of strings with basic vehicle description and plate numbers. The GUI 900 also includes one actionable button: a “Back” button 902 to return to the previous GUI 400. Each string in the table may be actionable. For example, upon the user pressing on the line showing “98765B” as a plate number, the GUI 900 is replaced with a GUI 1000 shown on FIG. 10.

FIG. 10 shows a GUI 1000 displaying the user information about a particular vehicle the user owns. Information includes unpaid fines, last vehicle inspection date, next vehicle inspection date, and so forth. The GUI 1000 also includes an actionable button or drop down button 1006 for the user to set the status of the user own vehicle, such as parked, stolen, pass, and the like. Note that when user changes his vehicle status, a request is routed to authorities and after proper approval, the status of the vehicle will be effective. The GUI 1000 also includes an actionable “Update” button 1004 that the user needs to press in order to update, in the database, the new status of the user vehicle chosen by activation of button 1006. The GUI 1000 also includes an actionable “Back” button 1002 to go to the previous GUI 900.

As discussed above, the database 114 of registered vehicles may maintain multiple accounts, with each associated with a particular vehicle. Each account may include records of a vehicle identifier, a vehicle plate number, vehicle information, vehicle owner information (e.g., name, mailing address, contact data), current vehicle status, payment information (e.g., credit card details, billing address), and billing records associated with prior charges for parking, traffic violations, toll roads, and or past purchases made with one or more merchants using the remote vehicle identification.

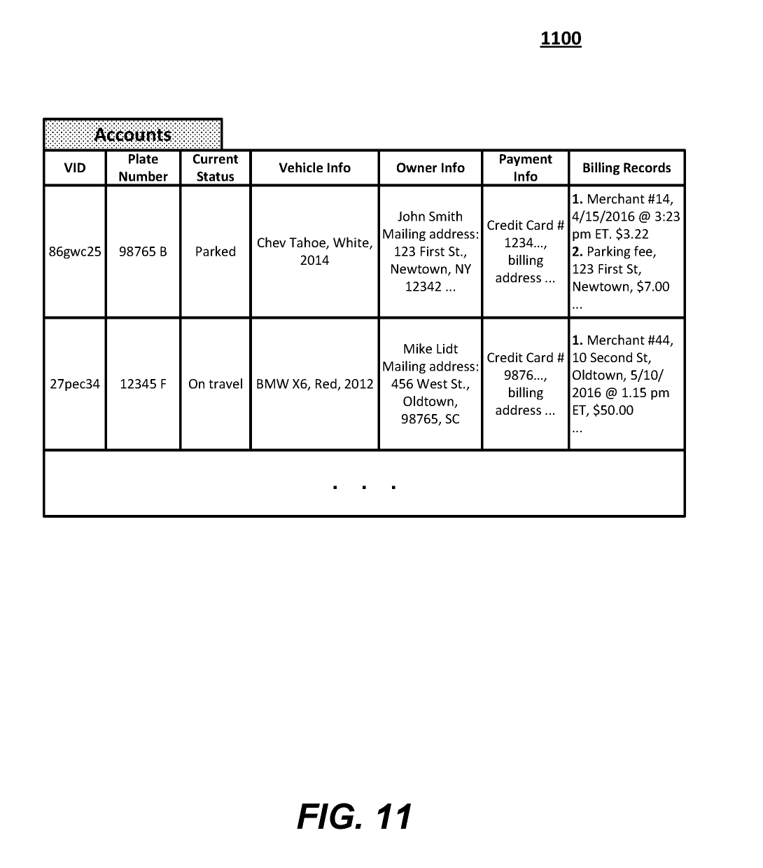

FIG. 11 shows an exemplary data structure 1100 of database 114 of registered vehicles. The database 114 can be maintained by a server such as a server 110 so that multiple electronic devices 106 may have access to it when needed. Notably, vehicle owners may edit some or all information provided in their corresponding accounts. For example, the owners may edit their personal information, payment information, contact information, and so forth.

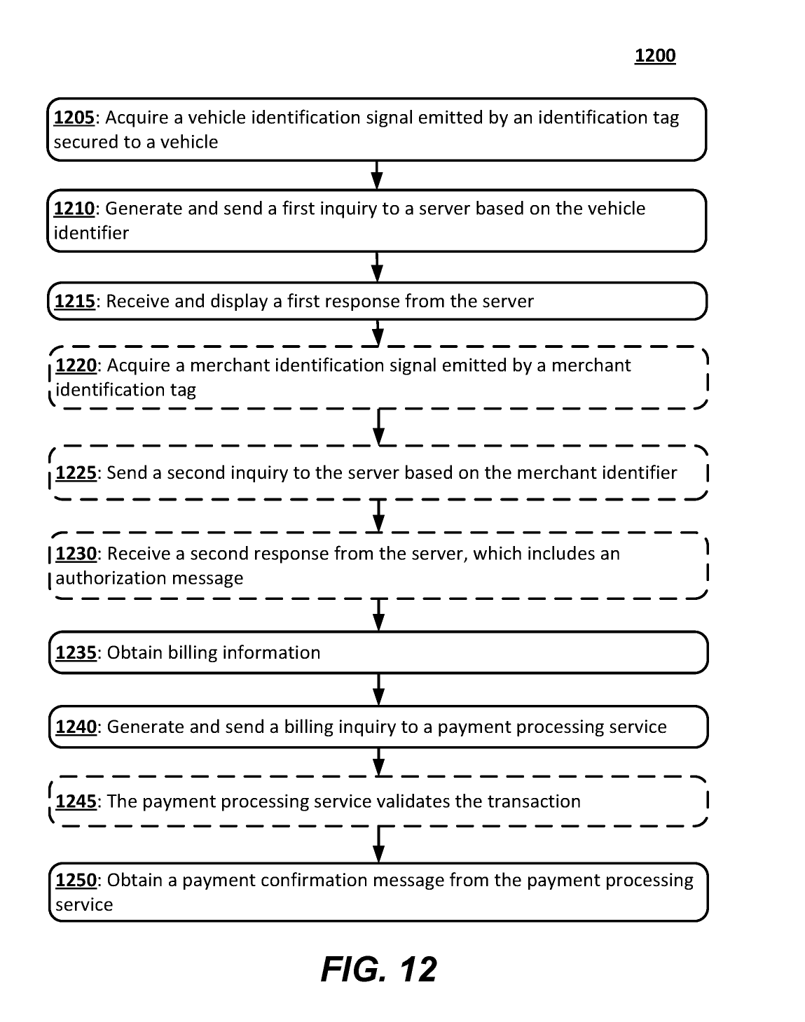

FIG. 12 shows a high-level process flow diagram of a method 1200 for processing payments based on remote vehicle identification, according to one exemplary embodiment. The method 1200 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 1200 is implemented by devices of environment 100B shown in FIG. 1B and FIG. 2. Importantly, the below recited steps of the method 1200 may be implemented in an order different than described and shown in FIG. 12. Moreover, the method 1200 may have additional steps not shown herein, but which can be evident for those skilled in the art from the present disclosure. The method 1200 may also have fewer steps than outlined below and shown in FIG. 12. In addition, at least some of the steps of method 1200 can be performed simultaneously.

The method 1200 commences at step 1205 with a first electronic device 106A acquiring a vehicle identification signal emitted by a vehicle identification tag 104 secured to a vehicle 102. The first electronic device 106A can acquire the vehicle identification signal when the vehicle 102 enters premises 120 of a merchant. This step can be performed automatically by the first electronic device 106; however, in alternate embodiments, an employee, agent or officer of the merchant shall initiate the scanning of the vehicle identification tag 104 by first electronic device 106A. The vehicle identification signal conveys a vehicle identifier associated with the vehicle.

In some embodiments, the method 1200 may commence with authenticating a user of the first electronic device 106A. For example, it can be needed to confirm that the current user of first electronic device 106A is an employee, agent, or officer authorized to use the first electronic device 106A in given circumstances. For these ends, the user of first electronic device 106A can be requested to provide credentials (e.g., a login, username, password, pass code, and the like), which are verified by a service implemented on one of the servers 110A-110C. In alternative or additional embodiments, the user can be authenticated by acquiring a sample of biometric information of the user and identifying the user based on that sample. The biometric information may include, but not limited to, fingerprints, iris/retina image, signature, voice, face image, and so forth.

At step 1210, the first electronic device 106A generates and sends a first inquiry to a server 110A maintaining a database 114 of registered vehicles with accounts of the drivers (owners). The first inquiry can include the vehicle identifier as obtained from the vehicle identification tag 104. The first inquiry can optionally include credentials of the user of the first electronic device 106A. The first inquiry causes the server 110A to address the database 114 and generate a first response to the first inquiry. The server 110A can also authenticate the user based on the credentials of the user. The first response can comprise vehicle information. The vehicle information may vary depending on circumstances and depending on a clearance level of the user. For example, if the user of the first electronic device 106A is an employee, his clearance level can be the lowest and the vehicle information can be limited. If the user of the first electronic device 106A is an officer of merchant, his clearance level can be highest and the vehicle information is not limited.

At step 1215, the first electronic device 106A receives the first response from the server 114 and displaying at least a part of the vehicle information.

At optional step 1220, the first electronic device 106A acquires a merchant identification signal emitted by a merchant identification tag 128 secured on premises 120 of a merchant. The merchant identification signal includes a merchant identifier associated with the merchant.

At optional step 1225, the first electronic device 106A sends a second inquiry to the server 110A, where the second inquiry comprises the merchant identifier as obtained at the step 1220. The second inquiry causes the server 110A to address the database 114 and generate a second response to the second inquiry. The second response comprises an authorization message for authorizing the first electronic device 106A to proceed with a monetary or non-monetary transaction. This step ensures that the electronic device 106A is located and operated on the premises 120 of the merchant. Note that the second inquiry can be sent simultaneously with the first inquiry.

At optional step 1230, the first electronic device 106A receives the second response from the server 110A including the authorization message. The authorization message enables the first electronic device 106A to generate a billing inquiry.

At step 1235, the first electronic device 106A obtains billing information. The billing information can be inputted by the employee, agent or officer of the merchant through an input device of the first electronic device 106A. The billing information can include data about goods or services to be purchased (e.g., goods/services codes) and optionally amount of goods or services to be purchased, price of goods or services to be purchased, and any other information required for the transaction. In some embodiments, the data about goods or services to be purchased can be automatically incorporated into the billing information after reading bar codes or QR-codes and addressing a corresponding database of goods and services.

At step 1240, the first electronic device 106A generates and sends a billing inquiry to a payment processing service 122. The billing inquiry includes the billing information and optionally one or more of the following: the vehicle identifier and the merchant identifier. The billing inquiry causes the payment processing service 122 to perform a monetary or non-monetary transaction based on the billing information, in accordance with one or more predetermined rules, and against an account associated with the owner or driver of the vehicle 102.

At optional step 1245, the payment processing service 122 validates the transaction. In a first example embodiment, the validation of the transaction includes the following operations. In response to the billing inquiry or billing information, the payment processing service 122 generates and sends a request message to a second electronic device 106B, which is associated with the owner or driver of the vehicle (not merchant). The request message of payment processing service 122 is configured to cause the second electronic device 106B to display the billing information on a display screen of the second electronic device 106B and prompt the owner or driver of the vehicle to confirm the billing information by making an input (e.g., clicking a button, entering a predetermined alphanumeric code, providing biometric data, etc.). Further, the payment processing service 122 receives a confirmation message from the second electronic device 106, where the confirmation message conveys a confirmation of the billing information. The confirmation can be generated in response to the input. Upon receipt of the confirmation message, the payment processing service 122 can perform the transaction according to predetermined rules.

In a second example embodiment, the validation of the transaction includes the following operations. In response to the billing inquiry or billing information, the payment processing service 122 causes displaying on a display screen of the first electronic device 106A, a user interface prompting the owner or the driver of the vehicle (not merchant) to input a predetermined alphanumeric code. When the code is received by the first electronic device 106A, the payment processing service 122 or the first electronic device 106A or any of the servers 110A-C or any additional server verifies the code inputted by the driver or owner by determining if it matches records in one of the databases. Upon successful result of verification, the payment processing service 122 can perform the transaction according to predetermined rules.

At step 1250, the first electronic device 106A obtains a payment confirmation message from the payment processing service 122. Moreover, the payment processing service 122 can optionally transmit a payment confirmation message to the second electronic device 106B. The payment confirmation message can include a date, time, and charge amount associated with the monetary transaction.

Thus, systems and methods for vehicle identification and processing payments based on remote vehicle identification have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method for processing payments based on remote vehicle identification, the method comprising:
acquiring, by a first electronic device, a vehicle identification signal emitted by a vehicle identification tag secured to a vehicle, wherein the vehicle identification signal conveys a vehicle identifier associated with the vehicle;
sending a first inquiry, by the first electronic device, to a server maintaining a database of registered vehicles, wherein the first inquiry comprises the vehicle identifier and credentials of a user of the first electronic device;
receiving, by the first electronic device, a first response from the server, the first response comprising vehicle information, wherein the vehicle information is generated based on a clearance level of the user;
displaying, by the first electronic device, the vehicle information;
obtaining, by the first electronic device, billing information;
sending a billing inquiry, by the first electronic device, to a payment processing service, wherein the billing inquiry comprises the vehicle identifier and the billing information, the billing inquiry causing the payment processing service to perform a monetary transaction based on the billing information and in accordance with one or more predetermined rules and against an account associated with an owner or a driver of the vehicle; and
obtaining, by the first electronic device, a payment confirmation message from the payment processing service.

2. The method of claim 1, wherein the vehicle identifier includes a unique code, the unique code being dynamically changing based on a predetermined rule maintained by the identification tag and the server.

3. The method of claim 1, wherein the first electronic device is associated with a merchant.

4. The method of claim 1, wherein upon receipt of the billing inquiry by the payment processing service, the method further comprising:
in response to the billing information, sending, by the payment processing service, a request message to a second electronic device, the second electronic device being associated with the owner or the driver of the vehicle, wherein the request message is configured to cause the second electronic device to display the billing information and prompt the owner or the driver of the vehicle to confirm the billing information by making an input; and
receiving, by the payment processing service, a confirmation message from the second electronic device, the confirmation message conveying a confirmation of the billing information.

5. The method of claim 1, wherein upon receipt of the billing inquiry by the payment processing service, the method is further comprising:
in response to the billing information, sending, by the payment processing service, a request message to the electronic device, wherein the request message is configured to cause the first electronic device to display the billing information and prompt the owner or the driver of the vehicle to confirm the billing information by making an input using the first electronic device; and
receiving, by the payment processing service, a confirmation message from the first electronic device, the confirmation message conveying a confirmation of the billing information.

6. The method of claim 1, further comprising:
acquiring, by the first electronic device, a merchant identification signal emitted by a merchant identification tag secured on premises of a merchant, wherein the merchant identification signal conveys a merchant identifier associated with the merchant;
sending a second inquiry, by the first electronic device, to the server, wherein the second inquiry comprises the merchant identifier;
receiving, by the first electronic device, a second response from the server, the second response comprising an authorization message, wherein the authorization message enables the first electronic device to generate the billing inquiry.

7. The method of claim 6, wherein the billing inquiry further comprises the merchant identifier.

8. The method of claim 1, further comprising:
acquiring, by the first electronic device, a merchant identification signal emitted by a merchant identification tag secured on premises of a merchant, wherein the merchant identification signal conveys a merchant identifier associated with the merchant; and
wherein the billing inquiry further comprises the merchant identifier.

9. The method of claim 1, further comprising:
displaying, by the first electronic device, a user interface prompting the owner or the driver of the vehicle to input a code;
receiving, by the first electronic device, the code inputted by the owner or the driver of the vehicle; and
verifying the code by the first electronic device and through the payment processing service and at least one of the server or an additional server.

10. The method of claim 1, further comprising:
acquiring, by a video service, a video stream from premises of a merchant associated with the first electronic device;
associating, by the video service, the video stream with the monetary transaction, the vehicle identifier, and the owner or the driver of the vehicle.

11. The method of claim 1, further comprising transmitting, by the payment processing service, the payment confirmation message to a second electronic device, the second electronic device being associated with the owner or the driver of the vehicle, wherein the payment confirmation message comprises a date, time, and charge amount associated with the monetary transaction.

12. A system for processing payments based on remote vehicle identification, the system comprising:
a first server maintaining a database of registered vehicles;
a payment processing service maintained by the first server or a second server;
a first electronic device comprising at least one processor and a memory storing processor-executable codes, wherein the at least one processor is configured to implement the following operations upon executing the processor-executable codes:
acquiring a vehicle identification signal emitted by a vehicle identification tag secured to a vehicle, wherein the vehicle identification signal conveys a vehicle identifier associated with the vehicle;
sending a first inquiry to the server maintaining a database of registered vehicles, wherein the first inquiry comprises the vehicle identifier and credentials of a user of the first electronic device;
receiving a first response from the server, the first response comprising vehicle information, wherein the vehicle information is generated based on a clearance level of the user;
displaying the vehicle information;
obtaining billing information;
sending a billing inquiry to the payment processing service, wherein the billing inquiry comprises the vehicle identifier and the billing information, the billing inquiry causing the payment processing service to perform a monetary transaction based on the billing information and in accordance with one or more predetermined rules and against an account associated with an owner or a driver of the vehicle; and
obtaining a payment confirmation message from the payment processing service.

13. The system of claim 12, wherein the vehicle identifier includes a unique code, the unique code being dynamically changing based on a predetermined rule maintained by the identification tag and the server.

14. The system of claim 12, wherein the first electronic device is associated with a merchant.

15. The system of claim 12, wherein the first electronic device is further configured to perform the following operations:
acquiring a merchant identification signal emitted by a merchant identification tag secured on premises of a merchant, wherein the merchant identification signal conveys a merchant identifier associated with the merchant;
sending a second inquiry to the server, wherein the second inquiry comprises the merchant identifier;
receiving a second response from the server, the second response comprising an authorization message, wherein the authorization message enables the first electronic device to generate the billing inquiry.

16. The system of claim 15, wherein the billing inquiry further comprises the merchant identifier.

17. The system of claim 12, wherein the first electronic device is further configured to perform the following operations:
acquiring a merchant identification signal emitted by a merchant identification tag secured on premises of a merchant, wherein the merchant identification signal conveys a merchant identifier associated with the merchant; and
wherein the billing inquiry further comprises the merchant identifier.

18. The system of claim 12, wherein the first electronic device is further configured to perform the following operations:
displaying a user interface prompting the owner or the driver of the vehicle to input a code;
receiving the code inputted by the owner or the driver of the vehicle; and
verifying the code through the payment processing service and at least one of the server or an additional server.

19. The system of claim 12, further comprising:
a video service maintained by the first server, the second server, or a third server, wherein the video service is configured to acquire a video stream from premises of a merchant associated with the first electronic device and associate the video stream with the monetary transaction, the vehicle identifier, and the owner or the driver of the vehicle.

20. A non-transitory processor-readable medium having instructions stored thereon, which when executed by one or more processors, cause the one or more processors to implement a method for processing payments based on remote vehicle identification, the method comprising:
acquiring a vehicle identification signal emitted by a vehicle identification tag secured to a vehicle, wherein the vehicle identification signal conveys a vehicle identifier associated with the vehicle;
sending a first inquiry to a server maintaining a database of registered vehicles, wherein the first inquiry comprises the vehicle identifier and credentials of a user of the first electronic device;
receiving a first response from the server, the first response comprising vehicle information, wherein the vehicle information is generated based on a clearance level of the user;
displaying the vehicle information;
obtaining billing information;
sending a billing inquiry to a payment processing service, wherein the billing inquiry comprises the vehicle identifier and the billing information, the billing inquiry causing the payment processing service to perform a monetary transaction based on the billing information and in accordance with one or more predetermined rules and against an account associated with an owner or a driver of the vehicle; and
obtaining a payment confirmation message from the payment processing service.
